(19) United States
(12) Patent Application Publication
(10) Pub. No.: US 2026/0163343 A1
(43) Pub. Date: Jun. 11, 2026

(54) Cable and Wire Security Enclosure and Methods of Use

(71) Applicants: C. Davis Woodbury, Roy, UT (US); Aaron Geary, Ogden, UT (US)

(72) Inventors: C. Davis Woodbury, Roy, UT (US); Aaron Geary, Ogden, UT (US)

(21) Appl. No.: 19/179,723

(22) Filed: Apr. 15, 2025

Related U.S. Application Data
(60) Provisional application No. 63/634,256, filed on Apr. 15, 2024.
(60) Provisional application No. 63/721,291, filed on Nov. 15, 2024.

(51) Int. Cl. H02G 3/04; G09F 13/04; H02G 3/38

(52) U.S. Cl. CPC H02G 3/0431; G09F 13/0404; G09F 13/0447; H02G 3/0418; H02G 3/286; G09F 2013/05

(57) ABSTRACT

An enclosure device for retaining cables therein is disclosed having a base that is mountable to fixed structure, such as the wall of a building and a cover removably disposed about the base. The base has flanges that extend away from its exterior surface that are mated with flanges extending way from an interior surface of the cover. The flanges are configured such that when the base and cover are coupled together, they form a cavity to house cables and/or wires therein.

### PRIORITY

This Application claims priority to U.S. Provisional Application No. 63/721,291 filed Nov. 15, 2024 and U.S. Application No. 63/634,256 filed Apr. 15, 2024, each entitled “Cable and Wire Security Enclosure and Methods” and which are incorporated by reference herein in their entirety.

### FIELD OF THE TECHNOLOGY

The present technology relates generally to cable and wire security enclosures used to locate and protect electronic cables, wires, lighting, control circuitry and the like.

### BACKGROUND

Generally speaking, cables/wires (the two are used interchangeably herein) are placed throughout structures. They can be used to provide electrical power supplies and communications equipment in the structure. Often these cables and/or wires are installed at the time of construction of the structure or facility and are embedded within the walls where they are mostly hidden and out of sight except for connection points or interfaces such as communication ports or electrical outlets.

Such traditional construction presents problems with the utilization of the cables and wires. For example, after the initial construction is complete, repair or upgrade of the cables and wires is difficult and expensive. This is difficult and cost is often caused by inaccessibility to the cables and wires that are within the walls which must be torn down, opened up, or overlaid in order to run new cables and wires.

Another problem with traditional construction is the fluctuating prices on building materials. With multiple options of materials to use for underlying construction, finish construction such as traditional trim and chair rails may not be versatile enough to securely attach to the wide variety of underlying construction materials that may be used. Hence, overlaying or finish trim, such as baseboards, chair rails and cable trays, may not securely attach to an existing original or underlying construction material causing installation challenges. Additionally, the height available to the trim may vary and existing trim materials are not typically adjustable in height to accommodate original or underlying construction that may vary in height.

Additionally, digital and cyber security is an ever-increasing issue for home, business, and government offices. One approach to digital and cyber security is to provide visibility to an entire communication network hardware layout including the cables and wires used throughout the network. Visibility is important to ensure that no tampering has occurred in the system or along any of its lines of cables and wires. Unfortunately, with traditional construction, cables and wires are not always visible due to being located within the walls.

### SUMMARY OF THE TECHNOLOGY

The inventor of the present technology has recognized that it would be advantageous to develop a cable and wire enclosure that is easily installed and accessible for locating and securing cables and wires during remodel or upgrade of a facility or structure and that matches the aesthetics of traditional construction techniques such as baseboard, crown molding, chair rail, and the like. Furthermore, the inventor has recognized that it would be advantageous to develop a cable and wire enclosure that provides easy visibility of cables and wires that are part of an electrical or communications network. Moreover, the inventor has recognized a need for a trim piece such as a cable tray or baseboard that has multiple fastening options designed to attach to common construction materials used today such as steel, aluminum, or wood two-by-fours, joists and the like. Additionally, the inventor has recognized that it would be advantageous to have a trim such as a baseboard or cable tray that can easily be adjustable in height so as to accommodate a variety of installation conditions.

Accordingly, the technology described herein provides for a cable enclosure for communications cabling, electrical wire, low voltage wire, lighting, sensors, and the like. The cable enclosure has a base that can be permanently attached to a facility structure such as a wall. The cable enclosure also has a removable top or cover that can be removably attached to the base. The top or cover is removably disposed about the base so as to allow cables and wires, and the like, to be selectively run (and re-run) and installed (or re-installed) within the enclosure and different times in the life cycle of the structure. The base can be sized and shaped to match the size of the outer wall covering of the facility structure the base is being attached to. In this way the base can be installed with an upper edge that is adjacent to and flush with the facility wall. The removable top can attach to the base in such a way that an outer side of the top is visible and positioned in relation to the surface of the wall to appear to be decorative trim such as base board, crown molding, chair rail, and the like. The top or cover can be made from a variety of materials and the outer surface can have a variety of aesthetic appearances. In one aspect, the cover (at least a portion thereof) is transparent or translucent such that a user can see within the enclosure for the entire length of the enclosure so as to be able to ensure tampering to the cables and wires within the enclosure has not occurred. It also permits the propagation of light from the enclosure according to certain aspects of the technology. In another aspect, the top is made from a transparent material to allow viewing into the entire enclosure for the entire length of the enclosure. In yet other aspects, the enclosure can be formed of a translucent, opaque, or solid material to match a desired aesthetic appearance. In use, the facility structure can be prepared either by remodel, or new construction techniques for a cable enclosure to be run along a wall of the structure with the upper edge of the base matching an adjacent profile of the wall. The base can be attached to the wall using provided attach points and attachment devices including, but not limited to, common fasteners and the like. Cables, wires, low voltage wires, lighting, sensors, and the like can be run through and attached to the base. The removable top can be attached to the base via the attachment devices molded into the base and the removable top. In the case where the enclosure is transparent or includes a transparent base or top, the user can then travel along the enclosure while viewing the interior of the enclosure for tampering of the contents of the enclosure. In this way, the enclosure can provide a high level of security to the contents of the enclosure.

The present technology also provides for a method of installing a cable and wire enclosure including determining a size and a length of needed enclosure from a surrounding structure. A base and cover of the enclosure can then be sized to fit along the surrounding enclosure such that a covered exterior surface of the enclosure is accessibly adjacent to an outer surface of the surrounding structure and with the enclosure at the predetermined length of the structure. The sized enclosure can then be attached to the surrounding structure using attachment points in the base of the enclosure. Cables, wires, and other electronics can then be placed in and extend through the base. The cover can then be placed on the base to form a chamber within the enclosure that contains the cables, wires, and other electronics. The cover can be removed periodically to check and ensure the security of the contents of the enclosure.

Additional features and advantages of the technology will be apparent from the detailed description which follows, taken in conjunction with the accompanying drawings, which together illustrate, by way of example, features of the technology.

### BRIEF DESCRIPTION OF THE DRAWINGS

FIG. 1 is a perspective view of a cable/wire enclosure system in accordance with an aspect of the present technology, shown attached to a structure such as a wall;

FIG. 2 is a perspective side view of the cable and wire enclosure of FIG. 1;

FIG. 3 is an exploded cross section side view of the cable and wire enclosure of FIG. 1;

FIG. 4 is a cross-section side view of the cable and wire enclosure of FIG. 1, shown with a cover removably disposed on a base;

FIG. 5 is a perspective view of a base of the enclosure of FIG. 1;

FIG. 6 is a perspective view of a base of the enclosure of FIG. 1;

FIG. 7 is a perspective view of a cover of the enclosure of FIG. 1;

FIG. 8 is a perspective view of a cover of the enclosure of FIG. 1;

FIG. 9 is a side cut-away view of a wall trim device in accordance with an embodiment of the present technology, shown in an assembled configuration;

FIG. 10 is a perspective assembly view of the wall trim device of FIG. 9;

FIG. 11 is a perspective assembly view of the wall trim device of FIG. 9;

FIG. 12 is perspective view of a wall trim system in accordance with an aspect of the present technology shown positioned on a wall with an internal corner and includes an internal corner cover of the wall trim system;

FIG. 13 is perspective view of a wall trim system positioned on a wall in accordance with one aspect of the technology with an external corner and includes an external corner cover of the wall trim system;

FIG. 14 is perspective view of a wall trim system in accordance with one aspect of the technology positioned on a wall with an external corner and includes an external corner cover and mid-track unions of the wall trim system;

FIG. 15 is a perspective view of a mid-track union shown joining two sections of a wall trim system in accordance with one aspect of the technology;

FIG. 16 is a view of a hallway showing aspects of the technology;

FIG. 17 is a view of a hallway showing aspects of the technology; and

FIG. 18 is a top view of a floor plan of a building showing how aspects of the technology operate to assist a user in an emergency situation.

### DETAILED DESCRIPTION

Reference will now be made to the exemplary aspects of the technology illustrated in the drawings, and specific language will be used herein to describe the same. It will nevertheless be understood that no limitation of the scope of the technology is thereby intended. Alterations and further modifications of the inventive features illustrated herein, and additional applications of the principles of the technology as illustrated herein, which would occur to one skilled in the relevant art and having possession of this disclosure, are to be considered within the scope of the technology.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

The term “cable” or “wire” as used herein is used as an example of an insulated wire or wires having a protective casing and used for transmitting electricity, data, or signals. It also includes a casing used to transmit light. The terms herein are used interchangeably.

An initial overview of the technology is provided below and specific technology embodiments are then described in further detail. This initial summary is intended to aid readers in understanding the technology more quickly, but is not intended to identify key or essential features of the technology, nor is it intended to limit the scope of the claimed subject matter.

In general, the technology provides for a cable enclosure for communications cabling, electrical wire, low voltage wire, lighting, sensors, and the like. The cable enclosure can include a base that can be permanently attached to a facility structure such as a wall. The cable enclosure can also include a removable top that can be removably attached to the base. The top can be removed to allow cables and wires, and the like, to be run and installed within the base. The base can be sized and shaped to match the size of the outer wall covering of the facility structure the base is being attached to. In this way the base can be installed with an upper edge that is adjacent to and flush with the facility wall. The removable top can attach to the base in such a way that an outer side of the top is visible and positioned in relation to the surface of the wall to appear to be decorative trim such as base boards, crown molding, chair rail, and the like. The top can be made from a variety of materials and the outer surface can have a variety of aesthetic appearances. In one aspect, the top can be transparent such that a user can easily see within the enclosure for the entire length of the enclosure so as to be able to ensure tampering to the cables and wires within the enclosure has not occurred. In another aspect, the base and the top can be made from a transparent material to allow viewing into the entire enclosure for the entire length of the enclosure. In yet other aspects, the enclosure can be formed of a translucent, opaque, or solid material to match a desired aesthetic appearance. In use, the facility structure can be prepared either by remodel, or new construction techniques for a cable enclosure to be run along a wall of the structure with the upper edge of the base matching an adjacent profile of the wall. The base can be attached to the wall using provided attach points and attachment devices. Cables, wires, low voltage wires, low voltage jacks, lighting, sensors, and the like can be run through and attached to the base. The removable top can be attached to the base via the attachment devices molded into the base and the removable top. In the case where the enclosure is transparent or includes a transparent base or top, the user can then travel along the enclosure while viewing the interior of the enclosure for tampering of the contents of the enclosure. In this way, the enclosure can provide a high level of security to the contents of the enclosure.

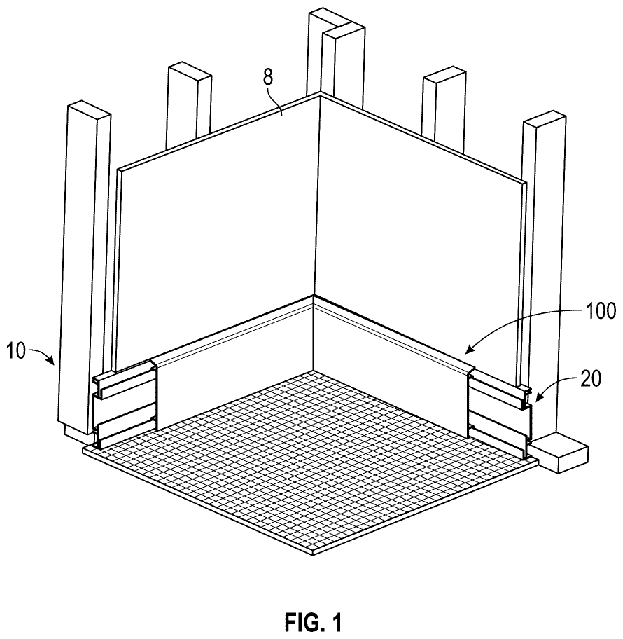

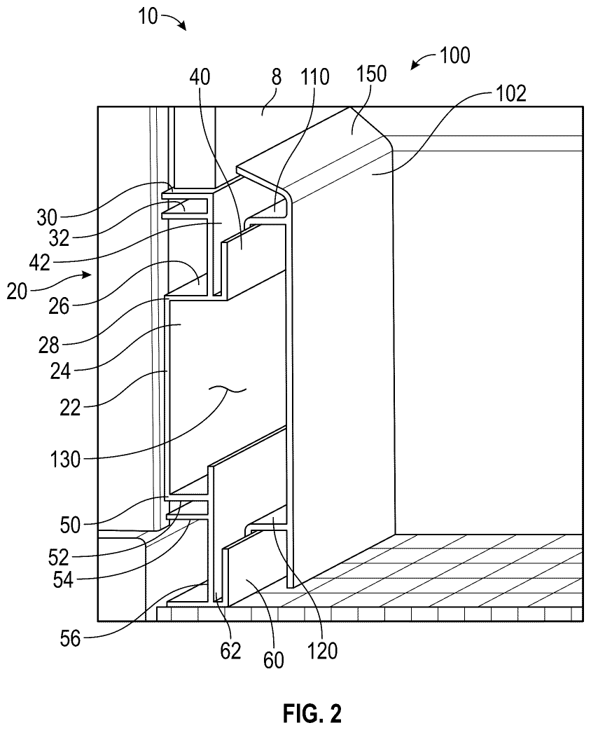

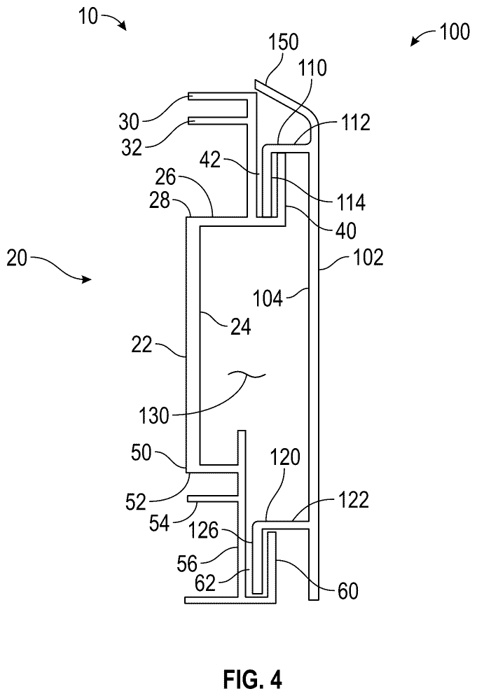

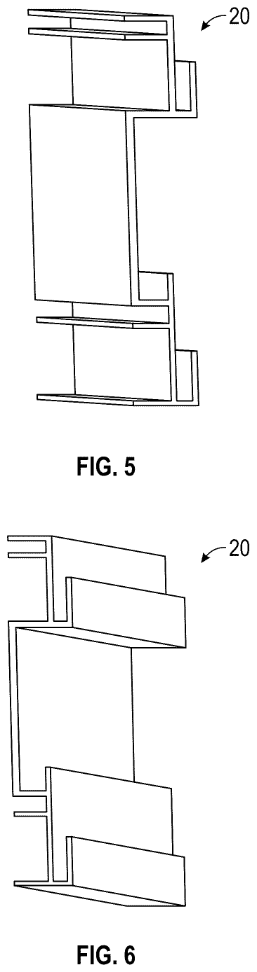

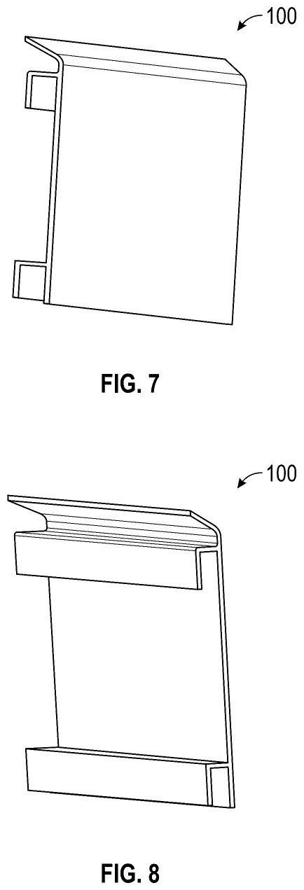

As illustrated in FIGS. 1-8, a cable/wire enclosure device, is shown in accordance with an aspect of the present technology for use in protecting and securing communications and electrical cables and wires. The enclosure 10 can include a base, indicated generally at 20 and a removable cover, indicated generally at 100.

The base 20 includes a substantially flat exterior base surface 22 and a corresponding interior base surface 24. The exterior and interior surfaces, 22 and 24 respectively, can extend a predetermined length, not shown. The predetermined length corresponds to a length of wall or other such structure over which the enclosure will extend with cables and wires run inside the enclosure. In one aspect of the technology, a fire-resistant liner is placed between the exterior base surface 22 and the wall in an effort to minimize risk of fire. In one aspect, the fire-resistant liner comprises sheet metal or a fire-resistant fabric comprising vinyl, clear vinyl, canvas, mesh, or polyethylene materials. In another aspect, vertical fire resistant blocks are disposed between the base 20 and cover 100 to minimize the spread of potential fire that may occur in the cavity between the base 20 and cover 100 about a longitudinal length of the enclosure.

In one aspect, the base 20 also includes an upper edge base wall 26 extending from an upper edge 28 of the base, and perpendicular to the base from the interior base surface 24 to a predetermined distance. The predetermined distance can correspond to a thickness of a wall covering structure 8 such as sheet rock, or lathe and plaster, and the like of the facility where the enclosure is being installed. In another aspect, the base 20 also includes an upper base attachment flange 30 extending from the upper edge base wall 26 to a predetermined distance, not shown. The base attachment flange 30 can be sized, shaped and positioned to provide an upper attachment point 32 to attach the base 20 to an adjoining structure 8.

In one aspect, the base 20 also includes an upper cover attachment flange 40 extending from the upper edge base wall 26 parallel to the upper base attachment flange 30 to a predetermined distance, not shown. The upper cover attachment flange 40 can form an upper cover attachment groove 42 with the upper base attachment flange 30. The base 20 can also include a lower edge base wall 50 extending from a lower edge 52 of the base and perpendicular to the base from the interior base surface 24 to a predetermined distance, not shown. The predetermined distance can correspond to a thickness of a wall covering structure 8 such as sheet rock, or lathe and plaster, and the like.

In another aspect, the base 20 includes a lower base attachment flange 54 extending from the lower edge base wall 50 to a predetermined distance. The lower base attachment flange can be sized, shaped and positioned to provide a lower attachment point 56 to attach the base to an adjacent structure such as a stud or wall. The base 20 can also include a lower cover attachment flange 60 extending from the lower edge base wall 50 parallel to the lower base attachment flange 54 to a predetermined distance, not shown. The lower cover attachment flange can form a lower cover attachment groove 62 with the lower base attachment flange 54.

The base 20 can be made from a manufacturing process such as extruded, drawn, cast, molded, blow molded, injection molded, or formed components. Additionally, the base can be made from a polymeric material such as polyethylene, PVC, Nylon, polypropylene, polycarbonate, and the like. In one aspect, the base can be extruded from a PVC material. The base 20 can be attached to the structure using attachment means as known in the art including mechanical fasteners, adhesives and the like. The upper and lower attachment flanges 30 and 54 can facilitate the correct placement of the base on the structure surface to which the base is to be attached. In one aspect, the attachment flanges can provide connection points to the structure surface to which the base is being attached.

In one aspect, the enclosure 10 includes a cover 100. The cover comprises an exterior cover surface 102 and corresponding an interior cover surface 104. The exterior and interior cover surfaces can extend a predetermined length. The length can correspond to the predetermined length of the base 20. The predetermined lengths of the base and the cover can correspond to a length of wall or installation structure in a facility where the enclosure 10 will be installed.

In one aspect, the cover 100 includes a cover upper edge wall 110 extending from an upper edge 112 of the cover. The upper edge wall 110 can extend from the interior surface 104 of the cover and perpendicular to the interior surface to a predetermined distance. The cover 100 can also include an upper base attachment flange 114. The upper base attachment flange can extend perpendicular to the cover upper edge wall 110 in an opposing direction to the direction of the upper cover attachment flange 40 on the base 20.

In one aspect, the cover 100 includes a cover lower edge wall 120 extending from a lower edge 122 of the cover. The cover lower edge wall 120 can be perpendicular to the cover from the interior surface 104 to a predetermined distance from the interior surface. The cover 100 can also include a lower base attachment flange 126. The lower base attachment flange 126 can extend perpendicular to the cover lower edge wall 120 in an opposing direction to the direction of the lower cover attachment flange 60 on the base 20. The cover 100 can also have a top flange 150. The top flange can cover the attachment points of the enclosure 10.

Like the base, the cover 100 can be made from a manufacturing process such as extruded, drawn, cast, molded, blow molded, injection molded, or formed components. Additionally, the cover can be made from a polymeric material such as polyethylene, PVC, Nylon, polypropylene, polycarbonate, and the like. In one aspect, the cover can be extruded from a transparent PVC material. The cover and base need not be made from the same material or manufacturing process and, in one aspect, are made from different materials through different processes.

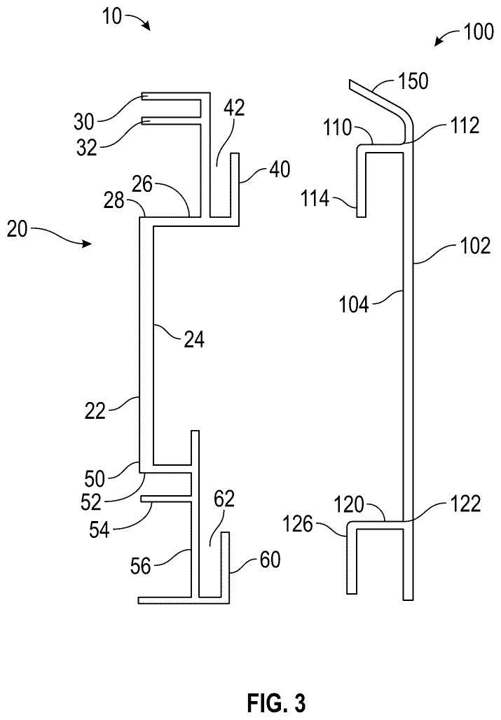

Advantageously, the cover 100 is removably coupled to the base 20. In one aspect, with reference generally to FIG. 3, the upper and lower base attachment flanges, 114 and 126 respectively, in the cover 100 can fit into the upper and lower attachment grooves, 42 and 62 respectively, in the base 20 that are formed by the upper and lower cover attachment flanges, 40 and 60 respectively. Thus, upper base attachment flange 114 fit into the upper groove 42 on the base 20, and the lower base attachment flange 126 fit within the lower groove 62 on the base 20. When the cover is on the base 20, the cover interior surface and the base interior surface form a cable and/or wire chamber, indicated generally at 130, where cables, wires, and other electronics are disposed.

In use, the base 20 is either formed on site to the desired predetermined length or cut to the predetermined length and attached to the facility using the attachment points. Cables and/or wires can then be run along and attached to the base interior surface. The cover 100 can then be attached to the base 20 to cover and protect the cables, wires and electronics disposed within the chamber 130 by the base and the cover.

Advantageously, a decorative trim can be attached to the outer surface of the cover 100. This makes the technology described herein particularly suited to remodel and new construction as baseboards can be used to match existing trim as desired for aesthetic appeal.

The present technology also provides for a method of installing a cable and wire enclosure including determining a size and a length of needed enclosure from a surrounding structure. A base and cover of the enclosure are then sized to fit along the surrounding enclosure such that a cover exterior surface of the enclosure is accessibly adjacent to an outer surface of the surrounding structure and with the enclosure at the predetermined length of the structure. The sized enclosure can then be attached to the surrounding structure using attachment points in the base of the enclosure. Cables, wires, and other electronics are then placed in and extend through the base. The cover can then be placed on the base to form a chamber within the enclosure that contains the cables, wires, and other electronics. The cover can be removed periodically to check and ensure the security of the contents of the enclosure.

In one aspect, the cover can be fabricated from a transparent material such as acrylic polyethylene. In this case, the contents of the enclosure can be readily viewed by visual examination through the cover to ensure the security of the contents of the enclosure.

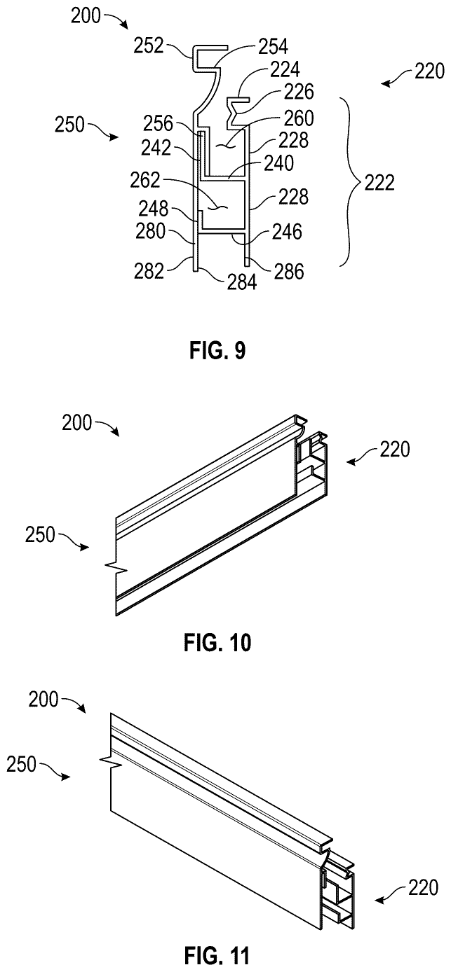

With reference generally to FIGS. 9-11, a wall trim device, is shown in accordance with an embodiment of the present technology for use in protecting and securing communications and electrical cables and wires. The wall trim device, shown generally at 200, can include a base, indicated generally at 220 and a removable cover, indicated generally at 250. The wall trim device 200 in this aspect forms an enclosure having the advantages and principles described above.

The base 220 comprises a plurality of fastener surfaces, indicated generally at 222. Each fastener surface can be sized and shaped to receive different type of fasteners. One fastener surface 224 includes a beveled flange 226 that can extend a longitudinal length of the base 220 and is sized and shaped to receive a fastener having a beveled head such as a wood screw as commonly used in wood-based framing. Another fastener surface 222 of the base 220 can include a flat surface 228. The flat surface 228 can be sized, shaped and positioned to rest flush against an adjacent mating surface of the underlying construction. In one aspect, the base can include a plurality of flat surfaces 228 to provide multiple attachment points of the base to the underlying construction or wall. The flat surfaces 228 can accommodate a fastener with a flat head such as a washer head screw as commonly used in steel stud construction.

In one aspect, the base 220 includes an attachment arm 240. The attachment arm 240 extends away from the base and providing an attachment point 242 for the removable cover to attach to. The base can also include a lower arm 246. The lower arm extends away from the base the same distance as the attachment arm. The lower arm includes a mating surface 248. The mating surface can be sized shaped and positioned to bear against a corresponding surface of the removable cover to provide stability and strength to the cover when attached to the base. The attachment arm 240 and the lower arm 246 can each form a cavity 260 and 262 respectfully, within the wall trim device. The cavities can be sized and shaped to receive wires, cables, cords, and the like.

In one aspect, the removable cover 250 comprises a decorative outer surface 252 and an operably attachable inner surface 254. The inner surface can include an attachment hanger 256. The attachment hanger can be sized, shaped and positioned to mate with and attach to the attachment arm 240 of the base. The removable cover comprises a lower face 280. The lower face can extend from the attachment hanger 256 to a bottom 282 of the removable cover 250. The lower face can include a lower portion 284 that can be adjustable to size the trim device to a desired height. A corresponding lower portion 286 of the base 220 can also be adjustable to size the entire device 200 to a desired height. In this way the trim device 200 can be adjusted to fit an existing installation space on a wall that the device is being attached to. In one aspect, the lower portions of the removable cover and the base can be cut to decrease the overall height of the device.

With reference generally to FIGS. 9-11 and 12-15, a wall trim system, is shown in accordance with another aspect of the present technology for use in protecting and securing communications and electrical cables and wires. The wall trim system, shown generally at 300, includes a base, shown generally at 220, a removable cover, shown generally at 250, an inside corner cover, shown generally at 330, and an outside corner, shown generally at 340. The base 220 can be similar to the base 220 described above. The base includes fastener surfaces, indicated generally at 222, and attachment surfaces, beveled flanges 226, flat surfaces 228.

The base 220 can be adjustable to size the base to a desired height corresponding to an available installation space on a wall. The base can include a lower portion 286 that can be sized to adjust the overall height of the base 220. In one aspect, the lower portion can be cut with a knife of saw to adjust the base to a desired height. In one aspect, the removable cover 250 has a decorative outer surface 252 and an operably attachable inner surface 254. The inner surface can include an attachment hanger 256. The attachment hanger can be sized, shaped and positioned to mate with and attach to the attachment arm 240 of the base.

In one aspect, the removable cover also includes a lower face 280. The lower face can extend from the attachment hanger 256 to a bottom 282 of the mating top 250. The lower face can include a lower portion 284 that can be adjustable to size the trim device to a desired height. A corresponding lower portion 286 of the base 220 can also be adjustable to size the entire device 200 to a desired height. In this way, the trim device 200 can be adjusted to fit an existing installation space on a wall that the device is being attached to. In one aspect, the lower portions of the removable cover and the base can be cut to decrease the overall height of the device.

The removable cover 250 can be operably attachable to the base 220 as described herein. The removable cover can also include a lower face 280. The lower face can include a lower portion 284 that can be adjustable to size the trim device to a desired height. The lower portion 284 can be adjusted to corresponding to the lower portion 286 of the base 220. In this way the removable cover 250 and the base 220 can both be adjustable to size the entire device 300 to a desired height. In one aspect, cover and the base can be cut with a knife or saw to the desired height needed for installation on a wall. In this way the trim device 200 can be adjusted to fit an existing installation space on a wall to which the device is being attached. In one aspect, the lower portions of the removable cover and the base can be cut with a knife or saw or other cutting means known in the art to adjust the overall height of the device. The removable cover 250 and the base 220, when coupled together can form cavities, indicated generally at 260 respectfully, within the wall trim system. The cavities can be sized and shaped to receive wires, cables, cords, and the like.

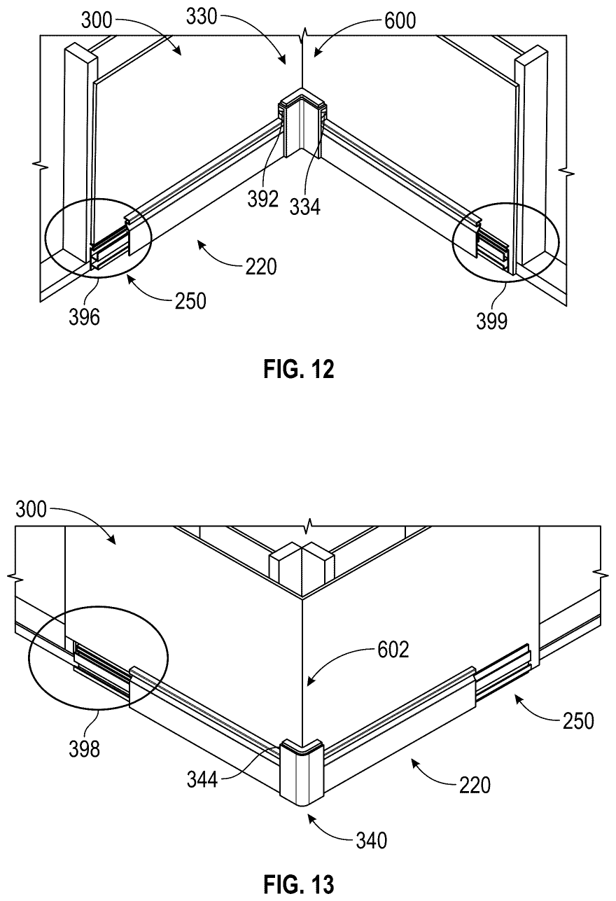

With reference generally to FIG. 12, in one aspect of the technology, the wall trim system 300 includes an inside corner, indicated generally at 330. The inside corner can attach to the removable cover 250 and the base 220. The inside corner 330 can couple and interface the removable cover and base so the trim system can continue uninterrupted around an internal wall corner, indicated generally at 600. The inside corner can be flexible to conform to the shapes and angles of the internal wall corner. In this way, the inside corner can form an internal angle of 180 degrees or less to conform to the existing shape of the wall to which it is being attached. The inside corner can include sides 334 that can be match cut to a profile of the removable cover 250 and base 220 so as to provide an aesthetically pleasing interface with the wall trim system.

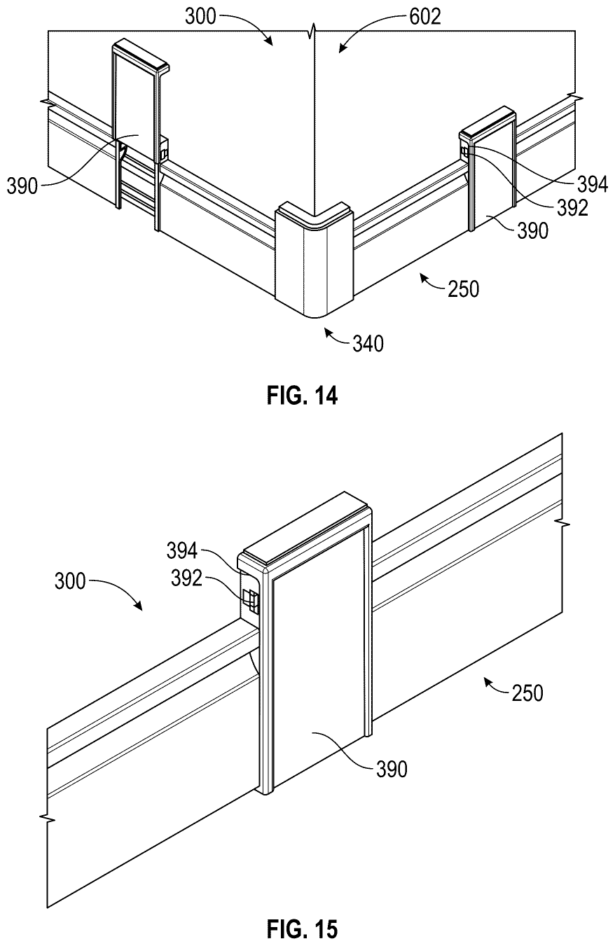

With reference generally to FIGS. 13-14, in one aspect of the technology, the wall trim system 300 also includes an outside corner indicated generally at 340. The outside corner can attach to the removable cover 250 and the base 220. The outside corner couples an interface to the removable cover and base so the trim system can continue uninterrupted around an external wall corner, indicated generally at 602. The outside corner can be flexible to conform to the shapes and angles of the internal wall corner. In this way, the outside corner can form an external angle of 180 degrees or more to conform to the existing shape of the wall to which it is being attached. The outside corner can include sides 344 that can be match cut to a profile of the removable cover 250 and base 220 so as to provide an aesthetically pleasing interface with the wall trim system.

With reference generally to FIGS. 14-15, in one aspect of the technology, the wall trim system 300 includes a mid-track union 390. The mid-track union 390 can attach to the removable cover 250 and the base 220. The mid-track union 390 can couple and interface to the removable cover and base so the trim system can continue on an external wall corner while joining two sections of the removable cover and base. The mid-track union 390 can include sides 394 that can be match cut to a profile of the removable cover 250 and base 220 so as to provide an aesthetically pleasing interface with the wall trim system. The inside and outside corners and the mid-track union can include and provide a junction 392 for coupling to wires located in the cavity formed between the base 220 and the removable cover 250. The junction can include wire to wire connections, plugs couplers, jacks, and other electrical low and high voltage connections.

As seen at 396 in FIGS. 12 and 398 in FIG. 13, the base 220 can be disposed below existing wall finishing treatments such as sheetrock or lathe and plaster. In this way, the base can be anchored directly to existing wall foundational materials such as studs in order to meet existing electrical code. Additionally, mounting in the space below the wall finishing treatment allows for a larger cavity in the wall trim device to carry more or larger wires and cables. Also, mounting in the empty space below the wall finishing treatment allows for the top removable cover to be flush with the visible wall surface and reduces the need for a sealant such as caulk to be needed to seal the top edge of the cover with the wall. As seen in 399 in FIG. 12, base 220 can be mounted directly on top of a visible surface of the wall finishing treatment. Mounting on this surface may be advantageous because such mounting would reduce the need to demolish and remove portions of the existing wall treatment.

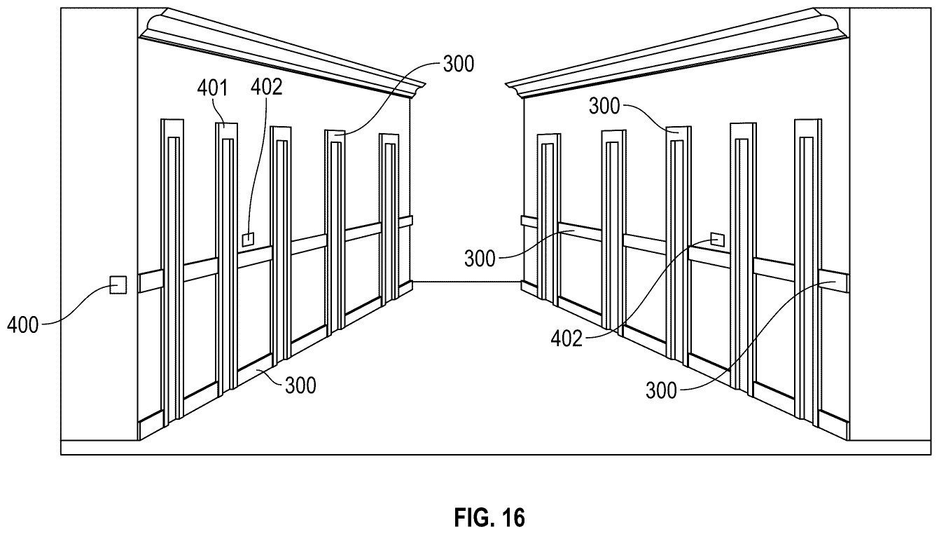

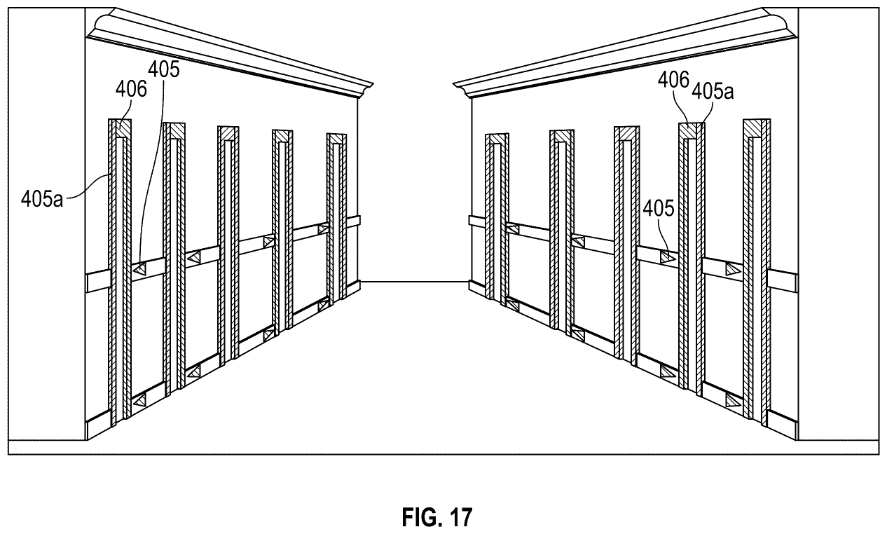

With reference generally to FIGS. 16-18, additional aspects of the technology include systems and methods of using the enclosure system described herein. In one aspect, one or more sensors 402 are disposed about surfaces adjacent to the wall trim system 300 or directly coupled to the wall trim system 300. In this aspect, the sensors 402 comprise motion sensors, heat sensors, moisture sensors, light sensors, smoke detectors, carbon monoxide sensors, and the like. In addition to sensors, microphones, speakers, and cameras are also disposed about surfaces adjacent the wall trim system 300 or directly coupled to the wall trim system. The sensors, cameras, speakers, and microphones are used in connection with a lighting system to direct interested persons to different locations within a building or other location.

In one aspect, the cover of the wall trim system 300 comprises a plurality of apertures therein that allow a lighting system comprising lighting devices (e.g., LEDs or other lights) disposed behind the cover to propagate light through the aperture and into a hallway or other open space. In another aspect, the lights are disposed behind a translucent or transparent portion of the cover 320 so that they are visible through the cover 320. The lights are coupled to a primary operations system or control unit to regulate the use and control of the lights under different scenarios and circumstances. The operations system may be located at the same location as the building wherein the wall trim system 300 is located or may be in a remote location such as a cloud-based operation comprising one or more processors.

In one aspect of the technology, the lighting system is used to assist persons in a building or facility to locate a room or location of interest in the building. For example, a person that is attempting to navigate a complicated system of halls in a hotel uses their key card or FOB to activate a card or FOB sensor 400 located near the elevator or at various locations in the hotel hallway on the floor where their room is located. Once the person touches the key card to the sensor (or otherwise activates the sensor) a specific color assigned to the key card is propagated through portions of the wall trim system 300 leading the person directly to their room. In one aspect, a portion of the door trim of the room comprises LED lighting therein and is colored to indicate that it is the correct room including lighting up the trim surrounding the correct door. The lights may be activated for a predetermined period of time or may remain on until the user touches their key card to a lock associated with the door. The lighting system can be used in connection with a speaker or intercom system to give verbal commands to a person as well as visual commands. For example, a person that is visually impaired will be given audible prompts through speakers installed in the wall trim system 300 to assist that person as they are directed to their room. While an example of a hotel room is provided, it is understood that the system may be used to navigate any building or to direct a person to a specific location or locations.

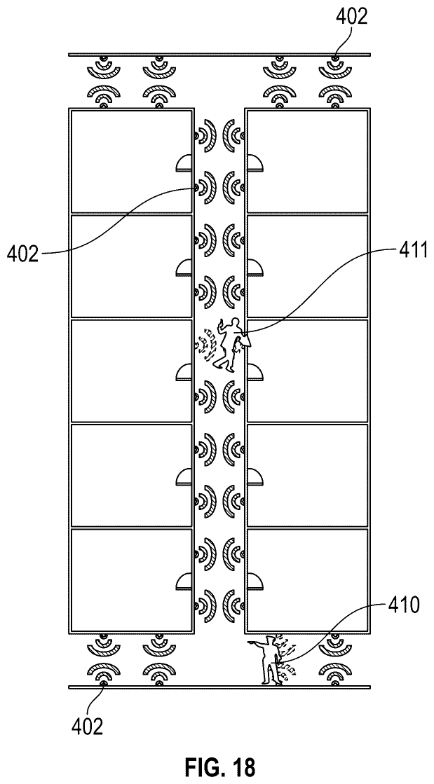

In another aspect of the technology, the lighting system is used in an emergency situation to direct persons to a safe exit or to direct emergency personnel to a specific location in a building. For example, in the event of a fire, the nearest emergency exit may not be the safest exit for people to evacuate the building. In this aspect, heat sensors, smoke sensors, carbon monoxide sensors and/or cameras are used to determine the safest route of evacuation. Once that is identified, a color-coded light (e.g., green) and/or light pattern indicates to persons the safest route of evacuation. That can include lighting up an arrow 405 in the cover corresponding to a portion 405a of the door trim showing the correct way to travel. Likewise, a color-coded light (e.g., red) or light pattern indicates to persons an unsafe route, shown generally at 406. With reference generally to FIG. 18, in the event that a fire fighter or other emergency personnel is looking for specific direction to a person or persons in danger, the lighting system is used to direct that person using color-coded lights and/or light patterns (e.g., green for the correct direction and red for the incorrect direction, etc.). In the event of an active shooter incident, similar sensors 402 and lighting operations (e.g., those discussed with respect to 405, 405a, and 406) can be employed to direct persons to the safest evacuation route and to direct emergency personnel 410 to the active shooter 411. Other emergency scenarios (e.g., flooding, hurricane, tornado, etc.) are contemplated herein, the purpose of the technology being effectuated to assist in directing persons to a desired location.

It is to be understood that the above-referenced arrangements are only illustrative of the application for the principles of the present technology. Numerous modifications and alternative arrangements can be devised without departing from the spirit and scope of the present technology. While the present technology has been shown in the drawings and described above with particularity and detail in connection with what is presently deemed to be the most practical aspects of the technology, it will be apparent to those of ordinary skill in the art that numerous modifications can be made without departing from the principles and concepts of the technology as set forth herein.

1. An enclosure device for retaining cables therein, comprising:
a base, the base comprising:
a substantially flat exterior surface and corresponding interior surface, the exterior and interior surfaces extending a predetermined length;
an upper edge wall extending from an upper edge of the base, the upper edge wall extending a predetermined distance perpendicular to the base;
an attachment flange extending from the upper edge base wall a predetermined distance, the attachment flange being sized, shaped and positioned to provide an upper attachment point to attach the base to an adjoining structure;
an upper cover attachment flange extending from the upper edge base wall parallel to the upper base attachment flange and forming an upper cover attachment groove with the upper base attachment flange;
a lower edge wall extending from a lower edge of the base perpendicular to the base;
a lower base attachment flange extending from the lower edge wall, the lower base attachment flange being sized, shaped and positioned to provide a lower attachment point to attach the base to an adjacent structure; and
a lower cover attachment flange extending from the lower edge wall parallel to the lower base attachment flange, forming a lower cover attachment groove with the lower base attachment flange;
a cover configured to mate with the base, the cover comprising:
an exterior cover surface corresponding to an interior cover surface, the exterior and interior cover surfaces extending a predetermined length corresponding to the predetermined length of the base;
a cover upper edge wall extending from an upper edge of the cover, the cover upper edge wall being perpendicular to the interior cover surface;
an upper base attachment flange extending perpendicular to the cover upper edge wall in an opposing direction to the direction of the upper cover attachment flange on the base;
a cover lower edge wall extending from a lower edge of the cover a predetermined distance perpendicular to the cover;
a lower base attachment flange extending perpendicular to the cover lower edge wall in direction opposite to the direction of the lower cover attachment flange on the base;
the cover being removably disposable on the base with the upper and lower base attachment flanges fitting into the upper and lower attachment grooves in the base formed by the upper and lower cover attachment flanges.

2. The device of claim 1, wherein the upper and lower edge base walls are sized and shaped to position the cover on an outer surface of an adjacent wall in a corresponding structure.

3. The device of claim 2, wherein the upper and lower base attachment flanges are sized and shaped to position the cover on an outer surface of an adjacent wall in a corresponding structure.

4. The device of claim 1, further comprising a plurality of cables disposed within a cavity formed between the base and the cover.

5. The device of claim 1, wherein the cover comprises one or more translucent windows or voids to propagate light therethrough.

6. A wall trim device, comprising:
a base configured to be attached to a wall, the base comprising a plurality of fastener surfaces, each fastener surface sized and shaped to receive a plurality of fastener types, wherein the base further comprises:
an attachment arm extending from the base providing an attachment point;
a lower arm extending from the base below the attachment arm having a mating surface, wherein the attachment arm and the lower arm each form a cavity within the wall trim device, the cavity being sized and shaped to receive cables therein;
a removable cover comprising an attachment hanger sized and shaped to mate with and attach to the attachment arm of the base.

7. The device of claim 6, wherein the plurality of fastener surfaces in the base include a preformed bevel flange providing an attachment point for fasteners having a beveled head.

8. The device of claim 6, wherein the plurality of fastener surfaces in the base comprises a plurality of flat surfaces sized, shaped and positioned to rest flush against an adjacent mating surface configured to receive a fastener.

9. The device of claim 6, wherein the base and the removable cover are adjustable on a lower wall to size the device to a desired height corresponding to an available installation space.

10. The device of claim 6, further comprising an inside corner cover configured to attach to the base and removable cover to continue the wall trim system around an internal wall corner; and further comprising an outside corner cover configured to attach to the base and the removable cover to continue the wall trim system around an external wall corner.

11. The device of claim 10, wherein the inside corner is flexible and forms an internal angle equal to or less than 180 degrees.

12. The device of claim 10, wherein the outside corner is flexible and forms an external angle equal to or greater than 180 degrees.

13. The device of claim 6, further comprising a mid-track union configured to attach to the base and the removable cover to join and continue the wall trim system along a wall.

14. The device of claim 13, wherein the mid-track union includes a junction for coupling cables in the cavity formed between the base and the removable cover.

15. The device of claim 14, wherein the cavity is sized and shaped to receive cables therein selected from a group consisting of electrical cables, communication cables, data cables, and fiber optic cables.

16. The device of claim 9, wherein the internal and external corners comprise a junction for coupling to cables in the cavity formed between the base and the removable cover.

17. A system for directing a person to a location of interest within a structure, comprising:
a base attached to a wall, the base further comprising an attachment arm extending from the base and providing an attachment point, a lower arm extending from the base below the attachment arm having a mating surface;
a removable cover comprising an attachment hanger sized and shaped to mate with and
attach to the attachment arm of the base;
a plurality of lights disposed within a cavity formed between the base and the removable cover; and
one or more processors coupled to a control unit, the control unit coupled to the plurality of lights.

18. The system of claim 17, further comprising a plurality of sensors coupled to the processor and control unit, the sensors comprising motion sensors, heat sensors, or moisture sensors.

19. The system of claim 18, wherein the control unit is configured to receive a signal from one of the plurality of sensors and send a signal to one or more light sensors in response to the signal from the one of the plurality of sensors.

20. The system of claim 19, wherein the signal to one or more light sensors is configured to selectively propagate a predetermined first wavelength of light to indicate a direction that a person should travel and a second wavelength of light to indicate a direction that a person should not travel.
